(19) United States
(12) Patent Application Publication
(10) Pub. No.: US 2004/0183948 A1
(43) Pub. Date: Sep. 23, 2004

(54) Real time smart image scaling for video input

(76) Inventors: Jimmy Kwok Lap Lai, Vancouver (CA); Barinder Singh Rai, Surrey (CA)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/392,152

(22) Filed: Mar. 19, 2003

(51) Int. Cl. H04N 9/64

(52) U.S. Cl. 348/581; 348/714

(57) ABSTRACT

Data from a video source are downscaled prior to storage in memory. This results in using less memory to store the image, less bandwidth in transmitting the image to the memory and display, and a reduction in power consumption. Downscaling may use methods of interpolation and a combination of dropping pixels and lines from the original image. The device and method require no decompression of data.

### BACKGROUND OF THE INVENTION

1. Field of the Invention

The invention generally relates to display devices and, more particularly, to a method for storing image data used by a display device.

2. Description of the Related Art

A typical method for displaying image data is depicted in FIG. 1. In this example, a video source 10 supplies, for example, a 640×480 image in 4:2:2 YUV format for each frame. The image will be reduced prior to presentation to the display 16. The 4:2:2 YUV format uses 16 bits (2 bytes) per pixel, thus each frame requires 614,400 bytes (640×480 pixels×2bytes/pixel) of memory 12. Storage to and reading from memory 12 requires 100% memory writing bandwidth. The video/display formatter 14 must read the entire 614,400 bytes for each frame and downscaling to the display 16 is performed by dropping pixels or lines or by interpolation.

Other methods have been devised for compressing data for presentation to display devices. U.S. Pat. No. 6,275,263 B1 to Hu describes a system employing the discrete cosine transform (DCT) and Huffman coding to perform bufferless data compression. U.S. Pat. No. 6,288,746 B1to Joo describes a system and method for encoding video images. U.S. Pat. No. 6,281,873 B1to Oakley describes a system for scaling VGA images to television format using a single integrated circuit that provides scaling and filtering.

### OBJECTS OF THE INVENTION

A principal object of the present invention is to provide a method for reducing the memory required when displaying a reduced sized image.

A second object of the present invention is to provide a device for reducing the memory required when displaying a reduced sized image.

Another object of the present invention is to provide a method where downscaling of video data is performed prior to memory storage.

Another object of the present invention is to provide a device where downscaling of video data is performed prior to memory storage.

Another object of the present invention is to provide a method where downscaling of video data is performed prior to memory storage, thereby reducing power consumption.

Another object of the present invention is to provide a device where downscaling of video data is performed prior to memory storage, thereby reducing power consumption.

A still further object of the present invention is to provide a method where downscaling of video data is performed prior to memory storage without the need for decompression.

A still further object of the present invention is to provide a device where downscaling of video data is performed prior to memory storage without the need for decompression.

These objects are achieved using a device and method where data from a video source are downscaled prior to storage in memory. This results in requiring less memory required to store the image. Additionally, less bandwidth in transmitting the image to the memory and display is required. Further, power consumption using this method is reduced since the number of data written into memory is decreased, thereby lowering the operating frequency of the circuitry related to the video input and memory.

### BRIEF DESCRIPTION OF THE DRAWINGS

In the accompanying drawings forming a material part of this description, there is shown:

FIG. 1 illustrating in block diagram format a typical image capture and display system; and

FIG. 2 illustrating in block diagram format the image capture and display system of the present invention.

### DESCRIPTION OF THE PREFERRED EMBODIMENTS

The present invention employs video downscaling techniques such as interpolation and dropping pixels and/or lines to reduce the memory and memory bandwidth requirements in an image display system. Some possible applications of this system include personal data assistants (PDAs), web tablets, cellular telephones, and automobile information and entertainment systems.

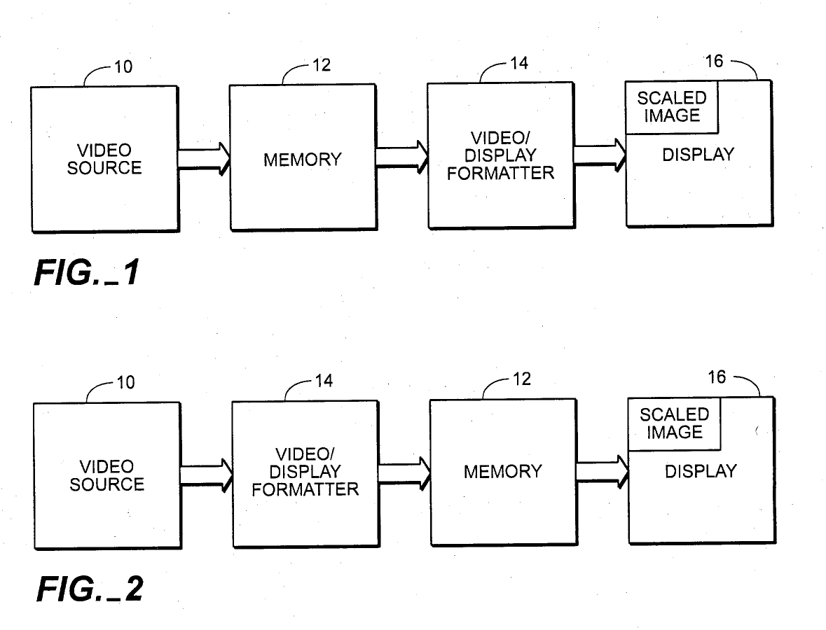

FIG. 2 depicts an example of the method and system of the present invention where the image is reduced to 25 percent of the full screen image. It will be understood by those skilled in the art that other image reductions amount would also benefit from the method of the present invention. For this example, the video source 10 supplies a 640×480 image in 4:2:2 YUV format for each frame. In the present invention, the image is reduced by the video display/formatter 14 prior to storage in the memory 12. As previously described, the 4:2:2 YUV format uses 16 bits (2 bytes) per pixel, thus each frame requires 614,400 bytes (640×480 pixels×2bytes/pixel). By reducing the image to 25 percent prior to storage in memory 12, the new image is 320×240 pixels. At two bytes/pixel, the reduced image requires only 153,600 bytes of memory 12. This is one-quarter of the memory requirement of the typical system where the image is reduced after storage to memory, as illustrated in FIG. 1. The video display formatter 14 can be implemented in any combination of hardware, software, firmware, ASIC, etc. In preferred embodiments of the video display formatter 14, the circuitry is configured or the software/firmware is programmed to (a) interpolate the fixed number of pixels per video frame corresponding to the video image to output some portion of the fixed number of pixels per video frame representing a reduced scale version of the video image, (b) eliminate a portion of the fixed number of pixels per video frame corresponding to the video image to output some portion of the fixed number of pixels per video frame representing a reduced scale version of the video image and/or (c) eliminate entire lines of the fixed number of pixels per video frame corresponding to the video image to output some portion of the fixed number of pixels per video frame representing a reduced scale version of the video image.

Additionally, the bandwidth required in both the memory writing and image displaying is reduced to 25% of that of the typical system. Power consumption using the present invention is reduced since the number of data written into memory is decreased, thereby lowering the operating frequency of the circuitry related to the video input and memory. One other advantage of this system over prior art system employing data compression is that those systems require data to be decompressed prior to use. The present invention does not require decompression of the data.

The present invention is a device and method where data from a video source are downscaled prior to storage in memory. This results in requiring less memory required to store the image, less bandwidth required in transmitting the image to the memory and display and a reduction in power consumption.

While the invention has been particularly shown and described with reference to the preferred embodiments thereof, it will be understood by those skilled in the art that various changes in form and details may be made without departing from the spirit and scope of the invention.

What is claimed is:

1. A video image scaling device comprising:
a video image source outputting a fixed number of pixels per video frame corresponding to a video image;
a downscaling device which outputs some portion of said fixed number of pixels per video frame representing a reduced scale version of said video image;
a memory for storing said portion of said fixed number of pixels per video frame; and
a display for presentation of said reduced scale version of said video image.

2. The device according to claim 1 wherein said downscaling device outputs some portion of said fixed number of pixels per video frame by interpolation of said pixels.

3. The device according to claim 1 wherein said downscaling device outputs some portion of said fixed number of pixels per video frame by eliminating a portion of said pixels from said video image.

4. The device according to claim 1 wherein said downscaling device outputs some portion of said fixed number of pixels per video frame by eliminating entire lines of said pixels from said video image.

5. A method for scaling a video image for future display wherein downscaling of said video image is performed prior to storage into memory.

6. The method according to claim 5 wherein said downscaling is accomplished by interpolation of pixels within said video image.

7. The method according to claim 5 wherein said downscaling is accomplished by eliminating a portion of the pixels from said video image.

8. The method according to claim 5 wherein said downscaling is accomplished by eliminating entire lines of the pixels from said video image.

9. A video image scaling device for use with a video image source that outputs a fixed number of pixels per video frame corresponding to a video image, a memory, and a display, comprising:
a downscaling device that receives said fixed number of pixels per video frame corresponding to a video image from said video image source and outputs some portion of said fixed number of pixels per video frame representing a reduced scale version of said video image for storage in said memory;
said display being responsive to said portion of said fixed number of pixels per video frame stored in said memory for presentation of said reduced scale version of said video image.

10. The device according to claim 9 wherein said downscaling device outputs some portion of said fixed number of pixels per video frame by interpolation of said pixels.

11. The device according to claim 9 wherein said downscaling device outputs some portion of said fixed number of pixels per video frame by eliminating a portion of said pixels from said video image.

12. The device according to claim 9 wherein said downscaling device outputs some portion of said fixed number of pixels per video frame by eliminating entire lines of said pixels from said video image.
